(19) United States
(12) Patent Application Publication
(10) Pub. No.: US 2021/0269228 A1
(43) Pub. Date: Sep. 2, 2021

(54) COLLAPSIBLE PACKAGE AND MEANS THEREFOR

(71) Applicant: INVENTORYTECH LIMITED, Christchurch (NZ)

(72) Inventors: Matthew CLARIDGE, Christchurch (NZ); Stephen Ian MANN, Christchurch (NZ); James WELLACOTT, Christchurch (NZ)

(73) Assignee: INVENTORYTECH LIMITED, Christchurch (NZ)

(21) Appl. No.: 17/255,762

(22) PCT Filed: Jun. 28, 2019
(86) PCT No.: PCT/IB2019/055480

§ 371 Date: Dec. 23, 2020

(30) Foreign Application Priority Data
Jun. 28, 2018 (NZ) 743922

(51) Int. Cl. B65D 83/08

(52) U.S. Cl. CPC B65D 83/0805; B65D 83/0894

(57) ABSTRACT

A dispenser for items to be withdrawn from packs containing such items within and comprising a dispenser. The dispenser has at least one pairing of a pack insertion zone and an item withdrawal zone whereby a stack of at least two packs can be maintained in the dispenser with the pack at the item withdrawal zone. This allows (a) individual item withdrawal via the item withdrawal zone from the pack and the dispenser and/or (b) empty pack removal via the item withdrawal zone. The empty packs can reconfigure from their form when full of their items to be pulled out of the dispenser.

The present invention relates to a collapsible package and means therefor. More particularly but not exclusively it relates to collapsible package that is collapsed by and through a slot smaller than the package's un-collapsed size.

### BACKGROUND

In some item dispensers, items are dispensed from packs with a set amount of items contained within. When items are emptied from a pack, a new pack of items is required to be appropriately positioned in the dispenser. Packs may be stacked on top of one another, with the bottom pack able to dispense items. Items within packs are withdrawn from the bottom pack when required. Typically the packs are loaded from the top of a dispenser, and are gravity fed down to a bottom dispensing region as lower packs are removed from the dispenser.

In prior art systems it may be required to take items out of packs delivered to a user, load the items into another dispenser pack, and then load said packs into a dispenser. Alternatively, the user can either take the individual items from the delivered pack and load the items into a dispenser. This can be time consuming. Other prior art systems allow for the delivered pack to be inserted directly into a dispenser, however these systems cannot have the empty packs easily removed without first removing stacked packs.

When the pack at the bottom dispensing region is empty, some prior art dispensing systems require the above stacked packs to be removed to get access to the bottom pack. This can be annoying for customers and/or can lead to the stack of packs not being put back in in the same order. This can lead to expired goods staying in a stack instead of moving to the dispensing region.

For the purpose of this specification, where method steps are described in sequence, the sequence does not necessarily mean that the steps are to be chronologically ordered in that sequence, unless there is no other logical manner of interpreting the sequence.

It is an object of the present invention to provide an easy to use dispensing system for storage more packs of products and ensure that the first, or more advanced, pack is used, thereby minimising the time in the unit of stock, and waste of expired items, alternately a dispensing system for packs containing items which overcomes or at least partially ameliorates some of the abovementioned disadvantages or which at least provides the public with a useful choice.

### STATEMENTS OF INVENTION

In a first aspect the present invention may be broadly be said to be a dispensing system for items to be withdrawn from packs containing such items within and comprising a dispenser; wherein the dispenser has at least one pairing of a pack insertion zone and an item withdrawal zone whereby a stack of at least two packs can be maintained in the dispenser with the pack at the item withdrawal zone allowing (a) individual item withdrawal via the item withdrawal zone from the pack and the dispenser and/or (b) empty pack removal via the item withdrawal zone; and wherein the empty packs reconfigure from their form when full of their items.

In one embodiment the pack at the item withdrawal zone allows (a) individual item withdrawal via the item withdrawal zone from the pack and the dispenser and/or (b) empty pack removal via the item withdrawal zone; by permitting the empty packs to reconfigure from their form when full of their items by a user extracting the empty pack via the withdrawal zone the reconfigured form allowing the pack to pass out of the withdrawal zone and the form when full preventing the pack from such withdrawal.

In one embodiment the dispenser comprises a housing and wherein the insertion zone comprise an insertion opening of the housing via which packs can sequentially pass into the housing.

In one embodiment the dispenser comprises a housing and wherein the withdrawal zone comprise a withdrawal opening of the housing via which packs can sequentially pass out the housing.

In one embodiment the dispenser comprises a housing and wherein the withdrawal opening and insertion opening in the housing are bridged by an intermediate housing opening.

In one embodiment each pack is configured and shaped complimentary to the insertion opening so as to require a specific orientation between the pack and the insertion opening in to allow the pack to be inserted into the insertion zone.

In one embodiment each pack is generally of a rectangular or square cuboid form and has a rear side which, in use, is inserted into the insertion opening first, an opposite front side which is presented to the withdrawal opening when in the withdrawal zone, a top wall joining the top edges of the rear side and front side and a bottom wall joining the bottom edges of the rear side and front side.

In one embodiment each pack is generally of a rectangular or square cuboid form and has a rear side which, in use, is inserted into the insertion opening first, an opposite front side which is presented to the withdrawal opening when in the withdrawal zone and moves through the withdrawal opening first when a user extracts the empty pack from the withdrawal zone.

In one embodiment each pack has a constant perimeter shape along its length between the front and back sides to allow its insertion through the insertion opening in a snug manner.

In one embodiment, the insertion zone is shaped similar to the perimeter shape.

In one embodiment, the perimeter shape is asymmetrical.

In one embodiment, the perimeter shape is trapezoidal.

In one embodiment, the top edge is of a different length to the bottom edge.

In one embodiment the presence of each pack within the dispenser is sensor detectable.

In one embodiment, the location and/or order of the at least two packs in a stack is sensor detectable.

In one embodiment, each item is sensor detectable.

In one embodiment, such a sensor is of the dispenser, is remote from the dispenser, or both.

In one embodiment each pack is configured to have an open condition to allow items to be taken from the pack and closed condition to prevent items from being taken from the pack.

In one embodiment each pack comprises a removable member that when removed, configures the pack to an open condition.

In one embodiment the condition open and/or closed is sensor detectable.

In one embodiment the location, condition, order, and number of items of each pack is sensed by a sensor or sensors.

In one embodiment, the sensors are one or more of capacitive sensing, optical sensing, and RFID sensing.

In one embodiment an inserted pack is not easily removed from the dispenser through the dispensing opening until emptied of its items.

In one embodiment, an empty pack cannot be removed.

In one embodiment an inserted pack cannot be removed from the dispenser through the dispensing opening when full of items.

In one embodiment a pull-tab is revealed on the package once it is emptied of items.

In one embodiment the pull-tab is configured initiate collapse of the pack when pulled to cause the pack to move through the dispensing opening.

In one embodiment the pack is configured to collapse sufficient to allow the pack to pass through the dispensing opening when the pull-tab is pulled in the direction of withdrawal, and pull the pack through the withdrawal zone.

In one embodiment the pack is configured to collapse sufficient to allow the pack to pass through the withdrawal opening only when the pull-tab is pulled in the direction of withdrawal to pull the pack through the withdrawal zone out of the dispenser.

In one embodiment the withdrawal opening is of a perimeter profile that prevents the pack from passing through the withdrawal opening unless its configured to a condition more collapsed than when full.

In one embodiment, when the last of the items to be withdrawn is withdrawn, a pull zone for the depleted package is revealed.

In one embodiment the insertion opening, withdrawal opening and intermediate opening form a single opening defining a non-upright “H” shape, the withdrawal opening being located less vertically than the insertion opening.

In one embodiment the withdrawal opening is of a smaller shape and or area than the front end shape or area of the pack.

In one embodiment the withdrawal opening is of a shape and configuration to present an interference of the passage of the pack in the withdrawal zone, through the withdrawal opening.

In one embodiment the withdrawal opening is configured to collapse and/or crush a pack that is withdrawn from the withdrawal zone opening.

In a further aspect the present invention may be said to be a dispenser for use in a system of any one of the preceding claims.

In one embodiment, the dispenser has a front wall comprising the insertion opening and withdrawal opening.

In a further aspect the present invention may be said to be a dispenser for items to be withdrawn from packs containing such items within and comprising a dispenser; wherein the dispenser has at least one pairing of a pack insertion zone and an item withdrawal zone whereby a stack of at least two packs can be maintained in the dispenser with the pack at the item withdrawal zone allowing (a) individual item withdrawal via the item withdrawal zone from the pack and the dispenser and/or (b) empty pack removal via the item withdrawal zone; and wherein the empty packs reconfigure from their form when full of their items.

In a further aspect the present invention may be said to be a pack for use with a dispenser as herein described.

In a further aspect the present invention may be said to be a pack for use with a dispenser system as herein described.

In one embodiment the pack has an extension that extends when in use in the dispenser, outside of the dispenser.

In one embodiment the extension is part of a removable member of the pack.

In one embodiment, the extension extends out of the opening of dispenser.

In one embodiment the extension extends out of the intermediate opening as the pack transitions from the insertion zone to the dispensing zone.

In one embodiment, the extension is T shaped.

In one embodiment, the extension acts as a handle to help a user to transition the pack downwards in the dispenser.

In one embodiment, the extension acts as a handle to remove the removable member.

In one embodiment, the dispenser comprises one or more tabs that prevent stored packs from sliding towards the withdrawal zone under their own weight.

In one embodiment, the packs can be manipulated to be pushed past the tabs.

In one embodiment, the tabs are flexible.

In one embodiment, the tabs are rigid.

In one embodiment, the packs are flexible.

In one embodiment, the tabs are located on sidewalls extending back from the front wall.

In one embodiment a said pack when removed from the withdrawal opening has its bottom wall pulled through first, whilst the top wall interacts with a wall of the dispenser at the dispensing opening, to thereby cause the pack to move to a more flattened condition to allow the pack to be removed from the dispenser through the dispensing opening.

In one embodiment, the pack is not damaged when removed from the withdrawal opening.

In a further aspect the present invention may be said to be a dispenser suitable for dispensing packs containing items each able to be dispensed from the pack when in the dispenser, the dispenser comprising a housing having a first wall opening to a containment region inside the housing via which a plurality of said packs can be loaded into the housing in a stack formation and a second wall opening of the housing allowing serial item withdrawal until a pack is empty of items, from the lowermost pack in the stack in the housing and thereafter removal, via the second wall opening, of the empty pack.

In one embodiment the second wall opening has a smaller area than the first wall.

In a further aspect the present invention may be said to be a pack of items, the items being available, or releasable so as to be available, for progressive withdrawal from the pack itself; wherein when none of the items have been withdrawn, the pack is of a thickness greater than that which it assumes, or can be caused to assume, when the pack is depleted of said items; and wherein, when the last of the items to be withdrawn is withdrawn, a pull zone for the depleted pack is revealed.

In one embodiment the pull zone is configured to collapse the pack when pulled.

In one embodiment the pack is configured to collapse when pulled at the pull zone, and pulled in the direction through a guide opening that is smaller than the area of the pack in the direction of the pull.

In a further aspect the present invention may be said to be dispenser suitable for dispensing packs containing items each able to be dispensed from the pack when in the dispenser, the dispenser comprising a dispensing pack and a housing having a first wall opening to a containment region inside the housing via which a plurality of said dispensing packs can be loaded into the housing in a stack formation and a second wall opening of the housing allowing serial item withdrawal until a dispensing pack is empty of items, from the lowermost pack in the stack in the housing presented at the second wall opening and thereafter removal, via the second wall opening, of the empty dispensing pack and a pack of items, the items being available, or releasable so as to be available, for progressive withdrawal from the dispensing pack itself through the second wall opening; wherein when none of the items have been withdrawn, the dispensing pack is of a thickness greater than that which it assumes, or can be caused to assume, when the pack is empty of said items and is larger than the second wall opening to prevent its removal through the second wall opening; and wherein, when the last of the items to be withdrawn is withdrawn, the empty dispensing pack is able to be pulled out of the second wall opening, the pack is configured to collapse when pulled at a pull zone of the pack, and pulled in the direction through a the second wall opening that is smaller than the area of the pack in the direction of the pull.

In one embodiment a pull zone for the empty pack is revealed when the last item is removed from the pack.

In a further aspect the present invention may be said to be a collapsible pack containing a plurality of items to be dispensed from the pack when in a dispenser having a housing with a dispensing opening via which the items in the pack can be grasped by a user for removal from the pack, the pack having at least two opposed walls and a base end at least partially enveloping and retaining a plurality of said items, the items presented at an end opposite the base end where the items can be grasped for removal, the pack being of a form that before removal of items cannot pass through the dispensing opening due to items keeping the two opposed sidewalls apart enough to prevent pack removal via the dispensing opening and that that once items are removed the pack can be grasped and pulled through the dispensing opening thereby collapsing the sidewalls permitting removal of the pack.

In one embodiment an EID tag is secured to the base.

In one embodiment at the base, the pack provides a spacer that spaces the items from the EID and creates a void between the items and the EID.

In one embodiment the spacer is of a configuration to also collapse when the pack is removed from the dispensing opening.

In one embodiment the EID is spaced at least 5 mm from the items.

In one embodiment the EID is spaced at least 10 mm from the items.

In one embodiment the EID is spaced at least 20 mm from the items.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification [and claims] means “consisting at least in part of”. When interpreting statements in this specification [and claims] which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.)

### BRIEF DESCRIPTION OF THE FIGURES

The invention will now be described by way of example only and with reference to the drawings in which:

FIG. 1: shows a top right perspective view of a dispenser with a pack being inserted into the insertion zone.

FIG. 2: shows a front view of FIG. 1.

FIG. 3: shows a cross-sectional side view of FIG. 1.

FIG. 4: shows an upper right perspective view of a dispenser with an item being removed from the withdrawal design.

FIG. 5: shows a front view of FIG. 4.

FIG. 6: shows a cross-sectional side view of FIG. 4.

FIG. 7-11: shows a cross-sectional side view of a dispenser showing the process of removing items from a pack, and subsequently removed the pack from the dispenser.

FIG. 12: shows a cross-sectional side view of a dispenser with a pack being inserted and falling towards a vertical orientation.

FIG. 13: shows a dispenser of FIG. 12, with the pack of FIG. 12 falling towards a stacked horizontal condition.

FIG. 14: shows a cross-sectional side view of a dispenser, showing the location of RFID sensors and RFID tags on the packs.

FIG. 15: shows a side view of a dispenser showing the location of a capacitive sensor.

FIG. 16: shows the location of an RFID tag on a removable member and on a pack.

FIG. 17: shows a side view of FIG. 16.

FIG. 18: shows a perspective view of a pack.

FIG. 19: shows a front view of FIG. 18.

FIG. 20: shows a side view of FIG. 18.

FIG. 21: shows a pack with the removable member removed.

FIG. 22: shows a pack with the items removed.

FIG. 23: shows a pack with a pull tab flipped over.

FIG. 24: shows a pack having as pull tab pulled to collapse the pack.

FIG. 25: shows an alternative embodiment of a pack.

FIG. 26: shows a side view of FIG. 25.

FIG. 27: shows a top right perspective of a dispensing system of an alternative embodiment.

FIG. 28: shows a front view of FIG. 27.

FIG. 29: shows a side view of FIG. 27.

FIGS. 30-34: show a process of an alternative embodiment of a dispensing system. FIG. 30: shows a cross-sectional side view of FIG. 27, with a pack at a withdrawal zone, and two stacked packs above.

FIG. 31: shows a pack at the withdrawal zone having the removable tab removed.

FIG. 32: shows a pack at the withdrawal zone emptied of items.

FIG. 33: shows the empty pack removed, and the stacked packs above.

FIG. 34: shows the above stacked packs moved down, so the lowermost pack is at the withdrawal zone.

FIG. 35: is a side view of a pack showing a first location of an RFID tag,

FIG. 36: is a side view of a pack showing the use of a spacer to separate the items in the pack from the RFID,

FIG. 37: shows the pack of FIG. 36 in a more deconstructed view to show the integration of the spacer with the side walls of the pack,

FIG. 38: shows the spacer being collapsed or collapsible,

FIG. 39: shows a stack of packs in side view each carrying items of a different length and with provision of different spacers in each pack to help present all of the items in each pack with their ends substantially commensurate.

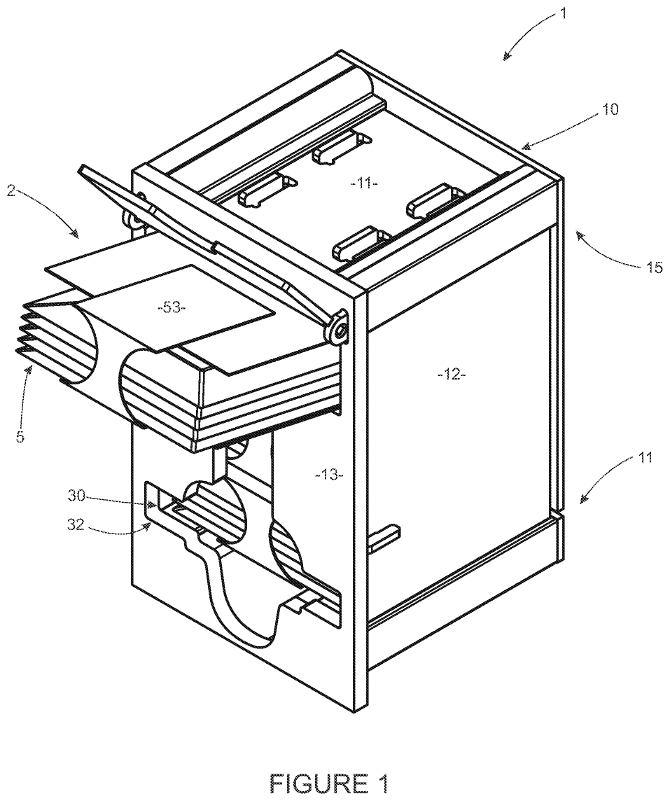

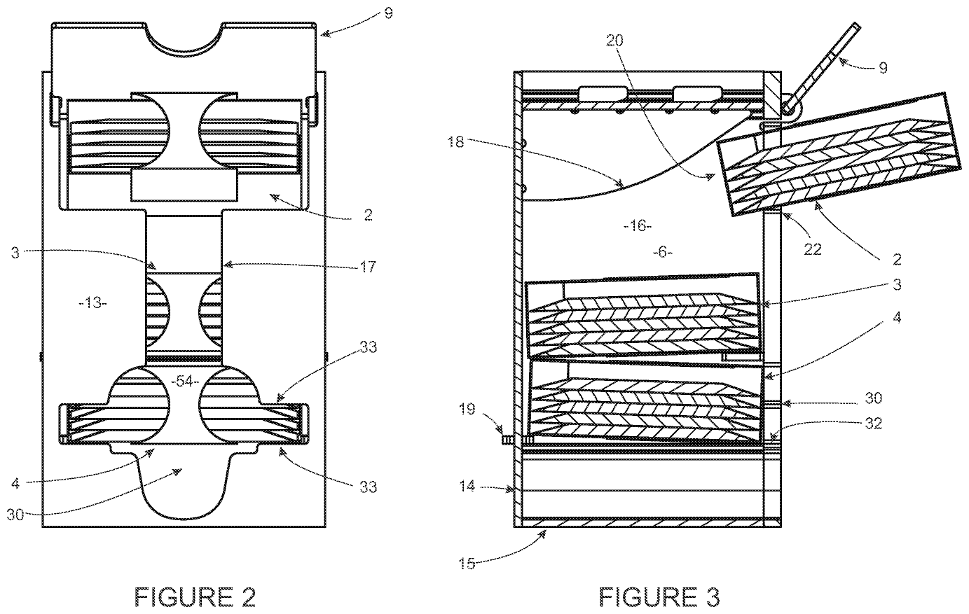

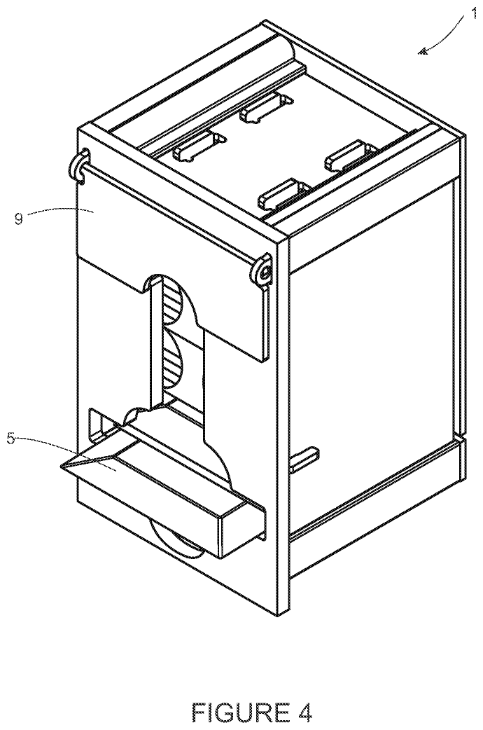

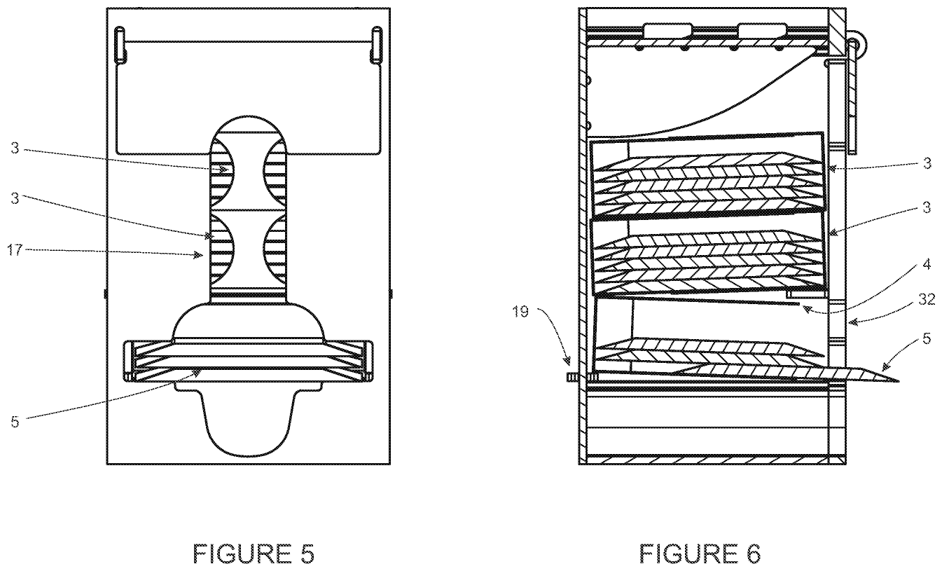

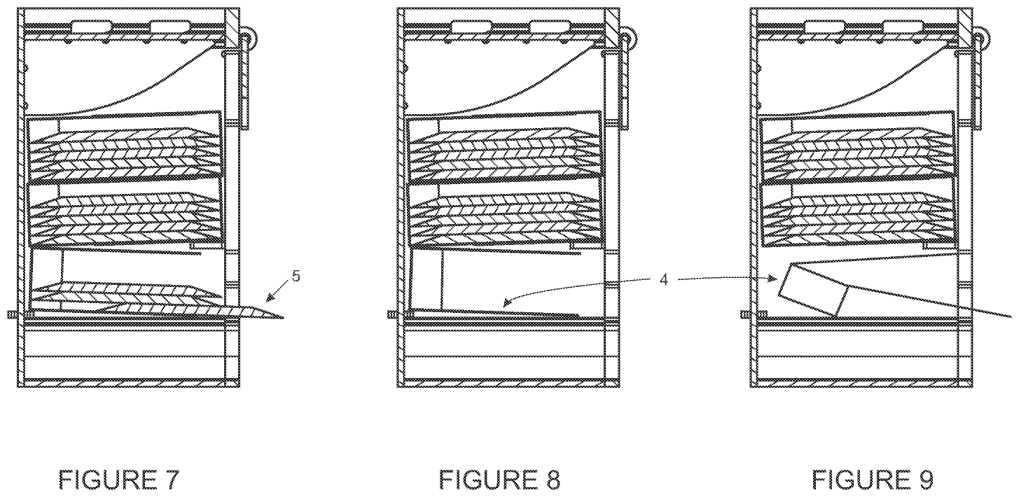

### DETAILED DESCRIPTION

With reference to the above drawings, in which similar features are generally indicated by similar numerals, a dispensing system according to an aspect of the invention is generally indicated by the numeral 1.

In one embodiment now described, there is provided a dispensing system 1 comprising of a dispenser 10 configured to dispense packs 2 containing items 5. The dispenser 10 is a housing having a casing and an interior. It is configured to receive packs 2 inserted through an insertion zone 20 of the dispenser and allow items 5 to be withdrawn from the pack 2 at a withdrawal zone 30. The dispensing system 1 may also allow a user, other person or database to know one or more of; how many packs 2 are within the dispenser 10, the location of packs within the dispenser 1, the order of said packs 2 with respect to each other, and the number of items 5 within a or each of said packs 2. Where mention of pack 2 is made, the pack 2 is of the same or similar in configuration to the stacked pack(s) 3, or withdrawing pack 4, which merely indicate where in the dispenser the pack 2 is.

An important aspect of this invention is that the dispensing makes it difficult for a user to remove a pack 2 from the withdrawal zone 30 without first removing all of the items 5 from said pack 2. It is also important that the easiest way to remove a pack 2, is by removing it via the withdrawal zone 30. There is no need to remove the stack of packs above the emptied pack to get to the emptied pack for its removal.

The dispenser 10 in one embodiment may comprise a top region 11, an opposite bottom region 15, a front wall 13 and rear wall 14 bounded by side walls 12. A preferred embodiment of the dispenser 10 has an insertion zone 20 for inserting a pack 2 located near the top region 11, and a withdrawal zone 30 for withdrawing a pack 2 or item(s) 5 from a pack located near the bottom region 15.

Preferably the insertion zone 20 and withdrawal zone 30 comprise or are an insertion zone opening 22 and a withdrawal zone opening 32. The openings 22 and 32 may be mere regions of a single opening 16 that joins up the insertion zone 20 to the withdrawal zone 30 as seen in the figures.

In a preferred embodiment the insertion zone 20 and the withdrawal zone 30 are located on the front face 13 of the dispenser 10. However, in other embodiments the insertion zone 20 and withdrawal zone 30 may be located on other faces of the dispenser 10, such as the insertion zone 20 being located at the top or on the rear wall 14 or a side wall 12 whilst the withdrawal zone 30 is located on the front wall 13, where the front wall 13 typically faces a user in operation.

Intermediate the insertion zone 20 and the withdrawal zone 30 may be the single opening or cavity 16 inside the housing which forms a pathway that allows packs 2 to travel from the insertion zone 20 to the withdrawal zone 30, as well as allowing packs to be stacked in a stacking zone 6. Intermediate the insertion zone 20 and the withdrawal zone 30, packs 2 can be stacked or stored. For example, two packs 2 may be entered into the insertion zone 20, the first pack 2 drops down to the withdrawal zone 30 to become a withdrawing pack 4. The second pack 2 is then inserted into the insertion zone 20 to drop down on top of the withdrawing pack 4 to become a stacked pack 3. The stacked pack 3 in one embodiment is not accessible to the withdrawal zone 30, but is instead stacked in a stacking zone 6.

The dispenser 10 may have a closure assembly 9 that can prevent a person having access to the insertion zone 20. In one form of the invention, the closure assembly 9 is a closable flap 9 as shown in FIG. 3. The flap 9 can be actuated by a user to gain access to opening 22.

In some embodiments a user may have limited access to the stacked packs 3. For example a slot 17 or door may give access to front end 53 of the stacked packs so that a user can jiggle the packs should they become jammed or out or orientation in the stacking zone 6. Preferably the access to the stacked packs is not large enough for a user to pull out a stacked pack 3 via the slot 17 from the dispenser 10.

The slot 17 also allows a user to have access to a pack to push down a pack from the stack to an empty withdrawal zone. In alternative embodiments there may be no slot, and instead there is a means for manipulation of the packs without touching or seeing the packs. For example a lever that when actuated may push packs towards the withdrawal zone.

The pack 2 has a complementary shape so that it fits through the insertion zone opening 22 without any substantial deformation of the pack 2. The fit is however, snug. For example, if a rear end 52 of a pack 2 was inserted into the insertion zone 20 through the insertion zone opening 22, the rear end 52 would have a complimentary, yet slightly smaller, shape to the insertion zone opening 22. For example, the rear end 52 as seen looking towards the rear end 52 has a perimeter shape of a trapezoidal, complimentary to the trapezoidal perimeter shape of the insertion zone opening 22. A trapezoidal shape is mentioned, but there may be many other shapes that are possible. Preferably the shape is not symmetric in plan view so the pack 2 is only able to be inserted in one orientation (i.e. rear end first, either top or bottom side up) into the insertion zone opening 22. I.e. if the pack 2 was flipped side on it would not fit into the insertion zone opening 22 side first. The pack may however be inserted either way up.

Preferably the pack 2 may have indicia on it directing the user as to what end to insert first and in what vertical orientation. For example the rear end 52 or the front end 53 first. Preferably in this embodiment the rear end 52 is inserted first through the insertion zone opening 22.

The front end 53 of a pack 2 is the end at which a user will remove items 5 contained within a pack 2, i.e. from a withdrawing pack 4. The pack 2 when in the withdrawal zone 30 typically is then able to have items 5 removed from it. The withdrawal zone opening 32, which is part of the withdrawal zone 30, allows access to the items 5 without the items 4 being hindered by the withdrawal zone opening 32. Preferably the withdrawal zone opening 32 is of a smaller area than the front 53 or rear 52 area so that the pack 2 cannot be pulled through the withdrawal zone opening 32 when in its standard opened condition. When a withdrawing pack 4 is located in the withdrawal zone 30, and the pack 2 is in the opened condition, then the items 5 can be removed easily from the pack 2 and the withdrawal zone opening 32.

Preferably the opening 32 has a height less than the height of a pack 2.

Once at the withdrawal zone 30, the pack 2 is then configured to have its items 5 removed from it, or the pack is already configured to have its items 5 removed from it.

Once the items 5 have all been withdrawn from a pack 2 and 4, the pack 2 and 4 may be then in a condition to be removed from the withdrawal zone 30 leading with the withdrawal zone opening 32.

In one embodiment, a user can change the condition of the withdrawing pack 4 from a closed condition to an open condition. When a pack 2 is inserted into the dispenser 10, it is typically in the closed condition already, if it has one. When the pack 2 is moved/moves down to the withdrawal zone 30, a user is then able to access the pack 2 and change the state of the pack 2 to an open condition. To change to an open condition, a user removes a removable member 54 that in the closed condition prevents removal of the items 5 from the pack. In the open condition the removable member 54 is completely removed, or at least partially removed, or at least does not hinder removal of items 5 from the pack 2. In a preferred embodiment, the removable member 54 is completely removable from the pack 2.

The removable member 54 preferably has, is, or comprises, a condition feature that can determine, or allow to be determined, the condition of a pack 2, i.e. if the pack 2 is open or closed. I.e. the condition feature can output a condition signal, or a sensor can read said condition feature condition. The condition feature in a preferred embodiment is an Electronic ID (EID) tag such as an RFID tag 40. In alternative embodiments an optical sensor may determine the status of the pack condition via visual means.

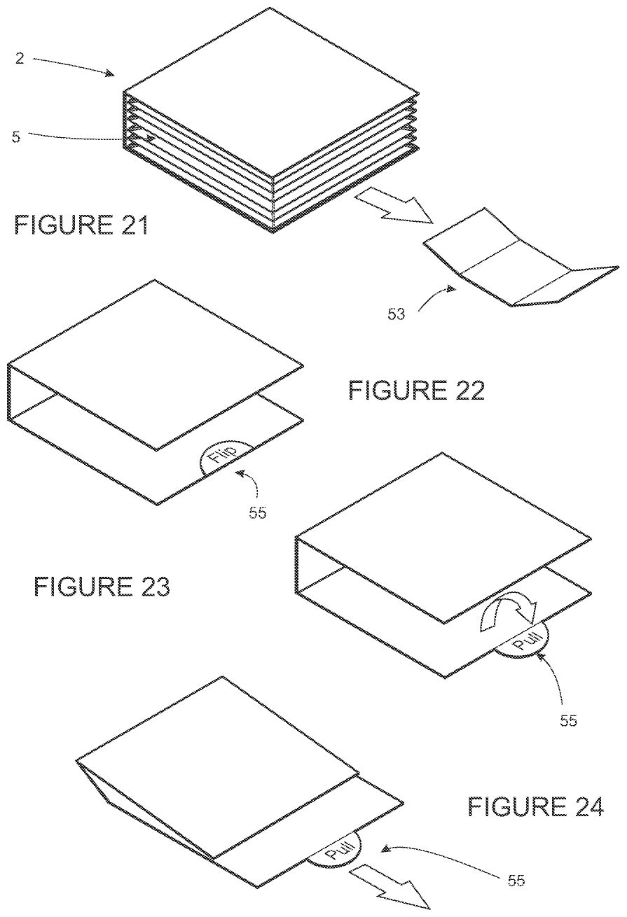

In a preferred embodiment once a pack 2 is empty, a pull tab 55 may be visible by the lack of items 5 covering it, so a user can pull the pull tab 55 to start initiation of the withdrawal of the pack 2 from the withdrawal zone 30 via the withdrawal zone opening 32. In alternative embodiments the pull tab 55 is always visible, regardless of the whether the packs contains items or not. The pull tab can be seen in FIGS. 21-23, which show the pull tab 55 being uncovered, flipped out, and then pulled.

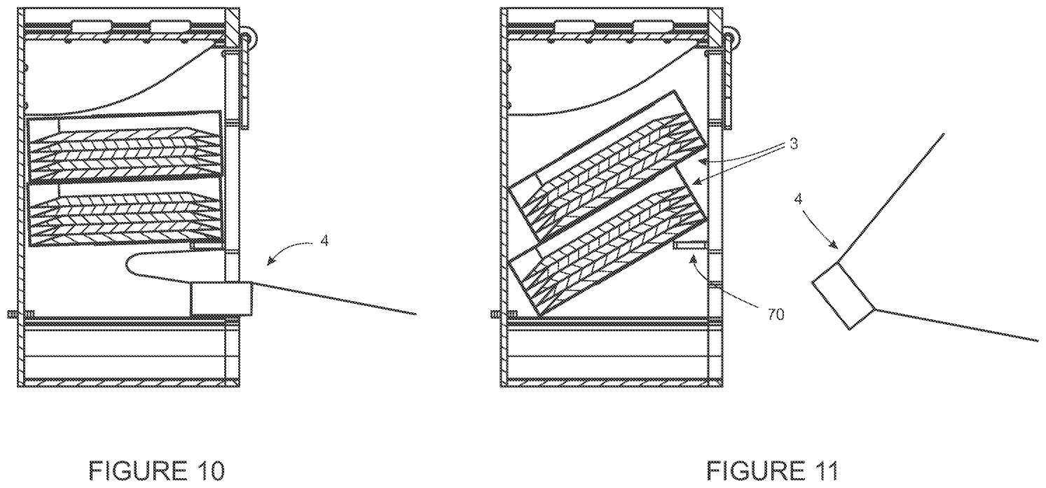

In the preferred embodiment, the pull tab 55 pulls the pack 2 through the withdrawal zone opening and at the same time allows the pack 2 to move to a collapsed or semi-collapsed condition. The collapsed or semi-collapsed condition allows the pack's cross-sectional area to be reduced to fit through the withdrawal zone opening 32 that is smaller than the non-collapsed area of the pack 2. A collapsed pack 2 can be seen in FIGS. 10 & 23.

Preferably the withdrawal zone opening 32 has a top and bottom edge 33 and side edges. In some embodiments the top and bottom edges 33 allow and guide the pack 2 into the collapsed state.

A collapsible pack may be configured in many ways. The pack may be substantially stiff when in the closed condition, and when in the open and empty condition, is substantially manipulable so it can crumple or deform through the withdrawal opening 32.

Once the pack 2 is completely or partially withdrawn from the withdrawal zone 30, the stacked pack 3 above can then fall down into the withdrawal zone 30 to replace the since withdrawn pack 2. From here a user can then if present, remove the removable tab 54 to allow access to the items 5 within the pack 2.

This invention negates the need to remove the stack of packs to gain access to the withdrawal zone 30 to remove an empty pack from the withdrawal zone 30, such as in prior art system.

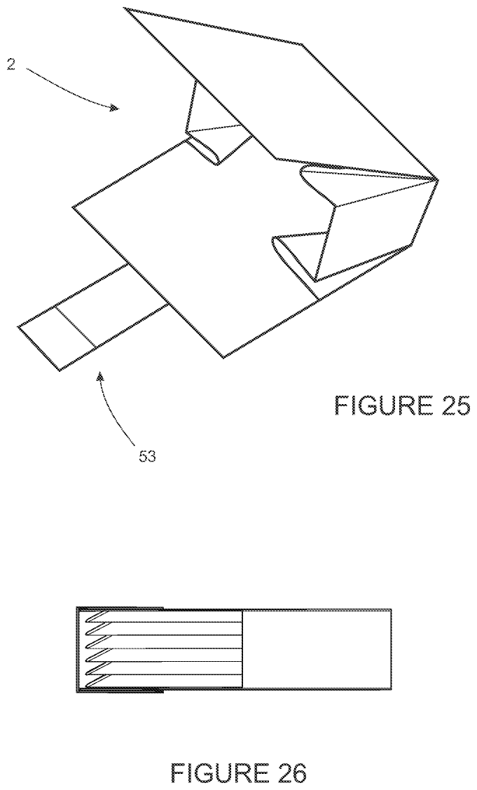

Another embodiment of a pack 2 is shown in FIGS. 25 and 26 where the pack 2 has side walls to contain the items within the pouch. These sides may or may not be attached to the top and bottom walls of the pack 2. FIGS. 25 and 26 shows an embodiment where the sidewalls are attached the top and bottom walls. Preferably the sidewalls are of a length that is equal or less than the height of the opening 32. This allows the pack 2 to have its bottom wall pulled through the opening, thereby twisting the sidewalls upright to be pulled through the opening, with the top wall to follow last. This process is shown in FIGS. 9 to 11.

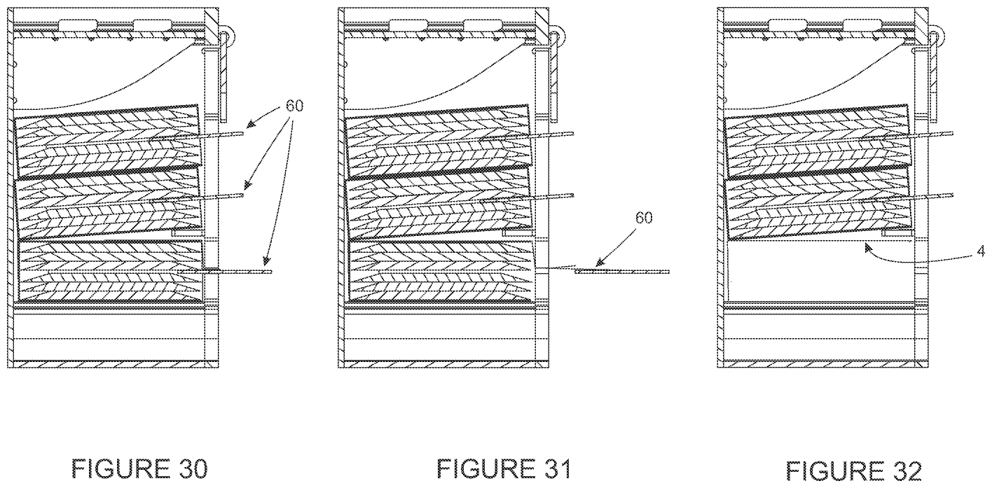

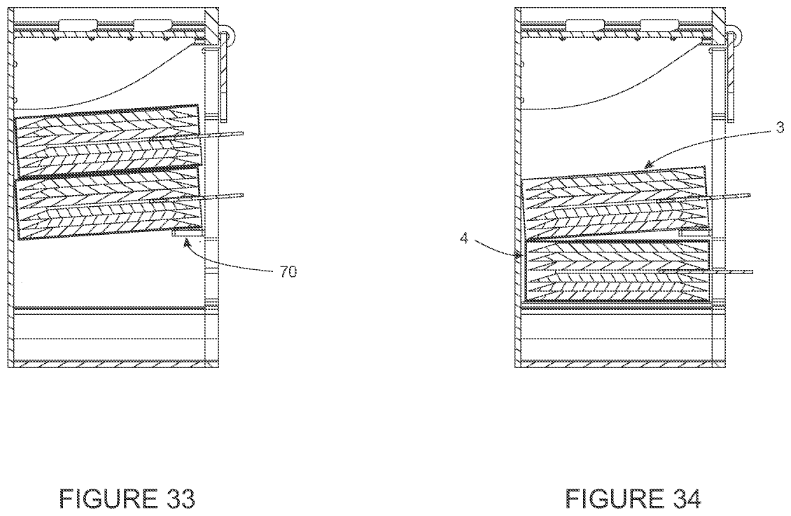

The dispensing system 1 may also comprise a stack support 70. The support 70 is shown at least in FIGS. 10-13 and 30-34. The support 70 supports or at least partially supports the packs 2 and the stack, excluding the packs at the withdrawal zone. The support 70 prevents the full weight of the stack of packs from being exerted onto the pack at the withdrawal zone. If the full stack of packs were supported by the pack at the withdrawal zone, the pack 4 at the withdrawal zone may be squished or collapse during removal of the items 5 or hindering removal of the pack 4 itself.

The support 70, in a preferred embodiment, are protrusions 70 extending internally from the front or side wall of the dispenser body 10. The protrusions 70 in one embodiment are rigid tabs that the packs need to be pushed past/around to get to the withdrawal zone. The packs may go past the protrusions, by the pack itself deforming slightly to go around the protrusion, the protrusion itself deforming, or the walls supporting the protrusions deforming, or two or more of the above. Alternatively, the protrusions may by elastically deformable so that a pack can deform the protrusion to get past it. Alternatively, the protrusions 70 may be spring biased, and a pushing of a pack against the protrusion will actuate the protrusion, and when the pack is past the protrusion the protrusion will spring back to its original condition.

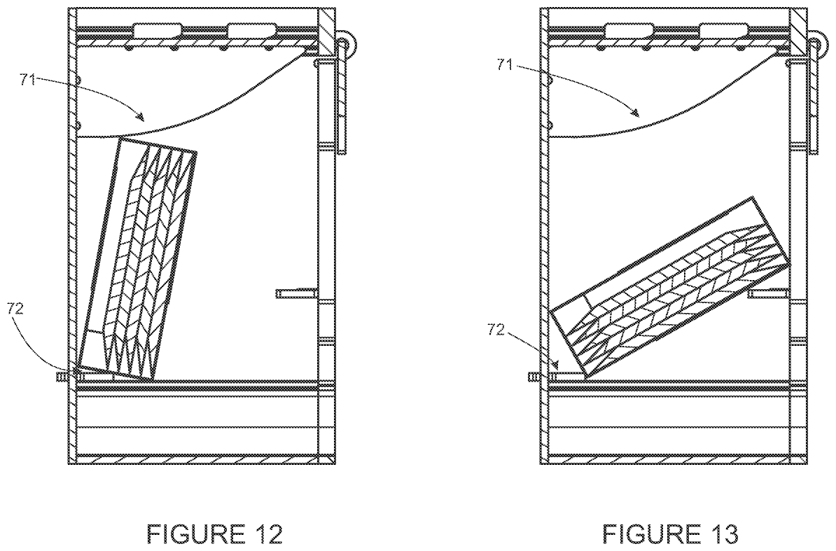

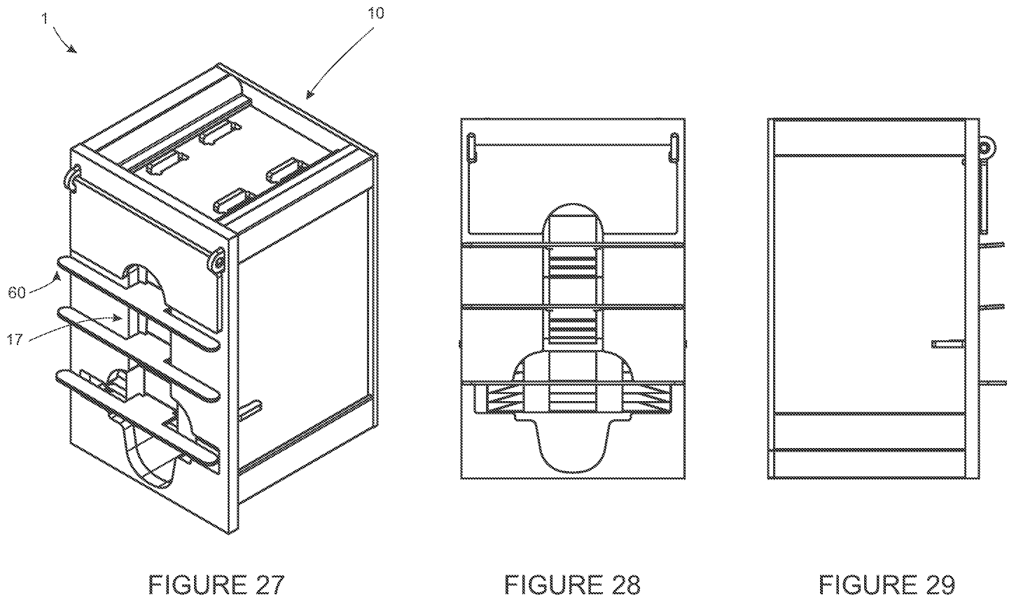

Along with the shaping and complementary dimensions of the pack, the housing may also comprise a guide 71 to guide a pack to fall flat in the dispenser. This can be seen in FIGS. 12 & 13, where in FIG. 12 a pack has fallen incorrectly towards a more vertical condition. The rear wall features and/or guide 71 stop the pack upending. This aspect is desirable when there are no other packs in the dispenser. The dispenser may also comprise a tab 72 that encourages a pack to fall forward towards the front wall or withdrawal zone. This embodiment is shown in FIGS. 12 & 13, where in FIG. 13, the pack has fallen forwards due to the pack's centre of gravity being over the pack's the tipping point due to the tab 72 not letting the pack upend. Alternative embodiments, where the packs are guided more carefully from the entry to withdrawal zone are shown in FIGS. 27-34, are described below.

In an alternative embodiment as shown in FIGS. 27-34, a pack 2 is shown with a T shaped member 60. The member 60 is connected to the removable member 54. The T member 60 may be a variety of shapes, not just a T shape. However the member preferably is able to achieve a variety of results described below. It is envisage other shapes, and/or multiple features could achieve some of the same results described below.

Firstly the T member 60 is another feature that helps prevents a user from inserting a pack 2 into the insertion zone 20 in the incorrect orientation. The T member 60 is wider than the insertion zone opening 22, thus preventing incorrect insertion direction of the pack 2. This may be combined with shaped perimeter area, i.e. trapezoid shaped, so that the pack 2 can only enter in one orientation.

The T member 60 in the preferred embodiment is located outside the front wall 13 of the dispenser 10. A shaft of the T member 60 connects the top of the T to the removable member 54, and is preferably complementary shaped to the slot 17. This allows the top of the T of the T member 60 to pass along and move outside of the front wall 13, whilst the shaft of the T member is allowed to be guided along the slot 17. The T member 60 is still able to connect to the removable member 54 located inside of the dispenser 10. In this manner, the T member can guide a pack through the opening 16.

The T member 60 locates the front 53 of the pack to towards the front wall 13 of the dispenser 10. This is because the top of T cannot pass through the slot, and neither can the pack. Having the front 53 of the pack always located towards the front wall 13 prevents misalignment of the packs 2 when inserted, stacked, moved along the stack, and removed from the stack to the withdrawal zone. It reduces the chances of packs 2 moving towards or to a vertical orientation in the single opening 16.

The T member 60 also aids in a user pushing down a stacked pack in the stack to the withdrawal zone, in some embodiments, past the protrusions 70.

Lastly, the T member 60 may also act as a handle for a user to easily remove the removable member 54. When a pack 2 is in the withdrawal zone, a user can grasp the T member 60, and via a pulling action on the T member 60, the T member 60 and removable member 54 is removed from the pack 2. The T member 60 may be integral with the removable member 54. FIG. 31 a shows the T member 60 and removable member 54 being removed from a pack 2.

It is envisaged that there may be multiple ways to guide the packs down to the withdrawal zone. For example with the packs may be profiled so that they are guided downwards in a parallel and flush like manner towards the withdrawal zone from the insertion zone. For example the top plan cross sectional shape of the pack maybe H shaped so it can be guided by complementary channels located on the internal walls of the dispenser. This embodiment would negate the need for the slot and T member.

Preferably the dispensing system comprises sensors that are able to sense numerous characteristics of the packs and items. In the embodiment where the insertion zone opening 22 and the withdrawal zone opening 32 are both located on the front wall 13 of the dispenser 10, then sensors may be located on the side wall 12. These side wall sensors are able to determine the number of packs 2 within the dispenser 10, as well as the quantity or weight of items 5 within each pack 2. Preferably the side wall sensors are capacitive sensors 42.

The capacitive sensing of the capacitive sensors 42 are able to sense or determine the level of content in each pack. Preferably the system can determine if an empty or partially used pack is placed back in the dispenser 10, as is capacitance reading is different from a full pack.

The capacitive sensing also allows the system to determine when an individual item is used.

There may be other types of sensing that allows the above features such as barcode, light, and/or RFID tags and sensors. These centres may read the position, location, expiry date, product details of the packs 2 and/or items 5.

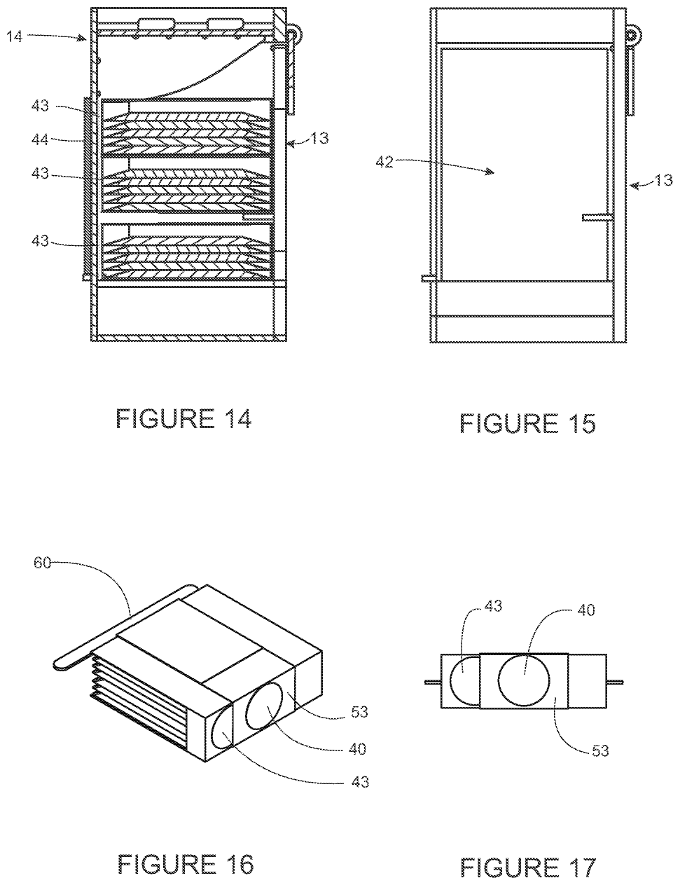

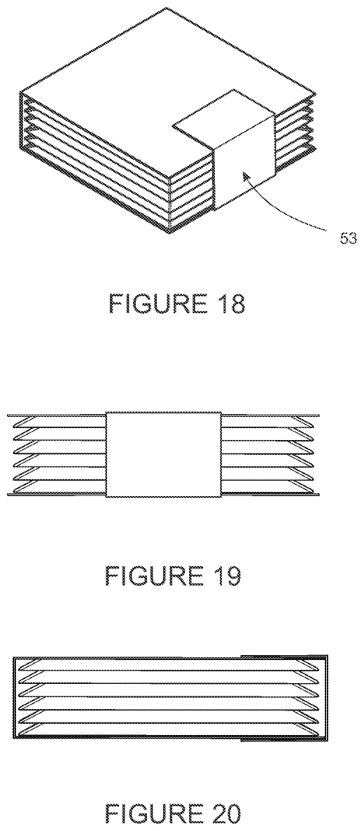

Preferably the system can sense when packs are inserted and withdrawn and maintain an order of the packs in the dispenser 10.

Where particular pack characteristics, excluding weight and quantity of items is required, is likely that a sensor that is not a capacitive sensor will be used. Such a sensor will likely be a barcode reading system, other optical system and/or RFID tag and reader. An RFID reader 44 and related RFID tag 43 & 40 are shown in FIG. 14 and FIG. 16. An RFID reader 44 is located on the back wall of a dispenser 10, and the RFID tags 43 and/or RFID tags 40 allocated on the back of each pack 2 and/or removable member 53. These RFID tags 43 & 40 have particular characteristics that are held in a database of the system, where each RFID tag's 43/40 characteristics relate to specific pack details. The system can read the RFID tag, relate the RFID tag to the specific item or pack on the database, and therefore determine the pack details. Such pack details may include the type of pack, the number of items within the pack, the type of items, the expiry date et cetera.

The system is simple for a user to use, the first pack in is also the first pack out. There's no need to shuffle packs during reloading or discharging.

The dispenser is quick to load. The present invention allows delivered packs including items, to be directly inserted into the present invention dispenser. Once the items have been removed from pack, then the pack can be easily removed from the withdrawal zone and discarded. The next pack in the stack can then slide down, or be actuated down into place.

It is commercially important that a dispenser according to the present invention does not require lots of time to maintain by the customer as reducing time spent on first aid kit management is a key value driver.

It is easy to load a new packs of items via the insertion opening. The packs can only be inserted in, in the correct orientation, making it easy for an unskilled user to restock the dispenser.

Due to the packs being stacked, users do not need to locate spare packs as they are already stacked in the dispenser. There may be many packs able to be stacked, for example one pack in a stack, or thirty packs in stack.

If a user pulls out a pack, it is difficult to insert the collapsed or deconstructed pack back into the dispenser.

Multiple spare packs allow for finer control of replenished stock, i.e. If five packs are stacked within a dispenser, then when one pack is removed, the automated system may choose to send a spare pack if other supplies for first aid need to be sent, otherwise the system can wait till a critical low level of one pack before the system sends more packs.

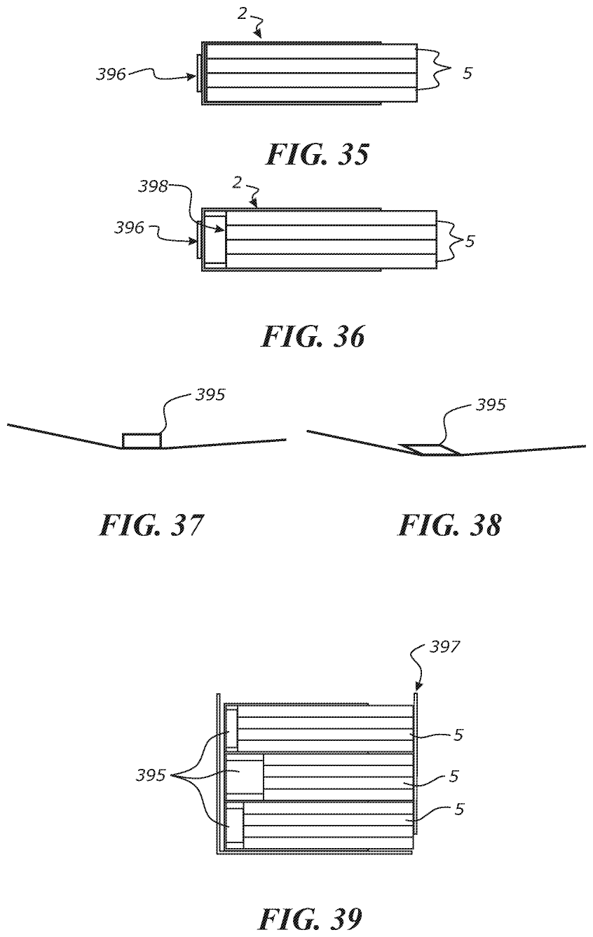

With reference to FIG. 35, there is shown a side view of a pack 2 carrying multiple items 5. Provided on the base (or alternative on a side wall) of the pack is an RFID 396. The RFID allows for a sensing of the presence or not of the pack in and potentially in a particular location of the dispenser. The RFID may also carry or relate to pack info such as the content of the pack, the packing date and other information.

It has been found that for better RFID reading a separation between the items 5 and the RFID 396 is desired. The pack preferably at its base hence includes a spacer 395 that allows for the items 5 to be spaced from the RFID 396. The spacer 395 may be part of the pack 2 and integral with the side walls or base of the pack as can be seen in FIG. 37. The spacer may be formed by folding of the paper or card outer shell of the packet 2, that may also define the side walls of the pack. In the preferred form the spacer 395 is able to collapse from an erect condition as shown in FIG. 37 to a more collapsed condition as seen in FIG. 38. The spacer hence is also able to adapt in shape for the purposes of the empty pack being pulled out of the dispensing opening of the dispenser.

In some situations, the packs in a dispenser may carry different shaped items. The items may be longer or shorter in some packs compared to other packs. The provision of a spacer 395 in packs allows for a spacer of an appropriate size to be provided within the pack so that the front edges 397 of the items are presented in line with each other as seen in FIG. 39. This helps ensure that the front edges of the items 5 in each pack present themselves substantially at a similar location in or at the dispensing opening of the dispenser. A person does not need to reach in further to reach some of the items than others. The spacer allows for substantially similar positioning of the front edges of the items to be provided independent of the length of the items within the pack. The items can span from the spacer to the front edge of the pack.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

1. A dispensing system for items to be withdrawn from packs containing such items within and comprising a dispenser; wherein the dispenser has at least one pairing of a pack insertion zone and an item withdrawal zone whereby a stack of at least two packs can be maintained in the dispenser with the pack at the item withdrawal zone allowing (a) individual item withdrawal via the item withdrawal zone from the pack and the dispenser and/or (b) empty pack removal via the item withdrawal zone; and wherein the empty packs reconfigure from their form when full of their items to a form more collapsed than when full, the withdrawal opening being of a perimeter profile that prevents the pack from passing through the withdrawal opening unless the pack is so reconfigured.

2. A system as claimed in claim 1 wherein the dispenser comprises a housing and wherein the insertion zone comprise an insertion opening of the housing via which packs can sequentially pass into the housing.

3. A system as claimed in claim 1 or 2 wherein the dispenser comprises a housing and wherein the withdrawal zone comprise a withdrawal opening of the housing via which packs can sequentially pass out the housing.

4. A system as claimed in claim 3 wherein the dispenser comprises a housing and wherein the withdrawal opening and insertion opening in the housing are bridged by an intermediate housing opening.

5. A system as claimed in anyone of claims 1 to 4 wherein each pack is configured and shaped complimentary to the insertion opening so as to require a specific orientation between the pack and the insertion opening in to allow the pack to be inserted into the insertion zone.

6. A system as claimed in anyone of claims 1 to 5 wherein each pack is generally of a rectangular or square cuboid form and has a rear side which, in use, is inserted into the insertion opening first, an opposite front side which is presented to the withdrawal opening when in the withdrawal zone, a top wall joining the top edges of the rear side and front side and a bottom wall joining the bottom edges of the rear side and front side.

7. A system as claimed in anyone of claims 1 to 5 wherein each pack is generally of a rectangular or square cuboid form and has a rear side which, in use, is inserted into the insertion opening first, an opposite front side which is presented to the withdrawal opening when in the withdrawal zone and moves through the withdrawal opening first when a user extracts the empty pack from the withdrawal zone.

8. A system as claimed in anyone of claims 1 to 7 wherein each pack has a constant perimeter shape along its length between the front and back sides to allow its insertion through the insertion opening in a snug manner.

9. A system as claimed in anyone of claims 1 to 8 wherein the presence of each pack within the dispenser is sensor detectable.

10. A system as claimed in anyone of claims 1 to 9 wherein each pack is configured to have an open condition to allow items to be taken from the pack and closed condition to prevent items from being taken from the pack.

11. A system as claimed in claim 10 wherein each pack comprises a removable member that when removed, configures the pack to an open condition.

12. A system as claimed in claim 11 wherein the condition open and/or closed is sensor detectable.

13. A system as claimed in anyone of claims 1 to 12 wherein the location, condition, order, and number of items of each pack is sensed by a sensor or sensors.

14. A system as claimed in anyone of claims 1 to 13 wherein an inserted pack is not easily removed from the dispenser through the dispensing opening until emptied of its items.

15. A system as claimed in anyone of claims 1 to 14 wherein an inserted pack cannot be removed from the dispenser through the dispensing opening when full of items.

16. A system as claimed in anyone of claims 1 to 15 wherein a pull-tab is revealed on the package once it is emptied of items.

17. A system as claimed in claim 16 wherein the pull-tab is configured initiate collapse of the pack when pulled to cause the pack to move through the dispensing opening.

18. A system as claimed in claim 16 wherein the pack is configured to collapse sufficient to allow the pack to pass through the dispensing opening when the pull-tab is pulled in the direction of withdrawal, and pull the pack through the withdrawal zone.

19. A system as claimed in claim 16 wherein the pack is configured to collapse sufficient to allow the pack to pass through the withdrawal opening only when the pull-tab is pulled in the direction of withdrawal to pull the pack through the withdrawal zone out of the dispenser.

20. A system as claimed in anyone of claims 1 to 19 wherein the insertion opening, withdrawal opening and intermediate opening form a single opening defining a non-upright “H” shape, the withdrawal opening being located less vertically than the insertion opening.

21. A system as claimed in anyone of claims 1 to 20 wherein the withdrawal opening is of a smaller shape and or area than the front end shape or area of the pack.

22. A system as claimed in anyone of claims 1 to 21 wherein the withdrawal opening is of a shape and configuration to present an interference of the passage of the pack in the withdrawal zone, through the withdrawal opening.

23. A system as claimed in anyone of claims 1 to 22 wherein the withdrawal opening is configured to collapse and/or crush a pack that is withdrawn from the withdrawal zone opening.

24. A dispenser for use in a system of any one of the preceding claims.

25. A dispenser for items to be withdrawn from packs containing such items within and comprising a dispenser; wherein the dispenser has at least one pairing of a pack insertion zone and an item withdrawal zone whereby a stack of at least two packs can be maintained in the dispenser with the pack at the item withdrawal zone allowing (a) individual item withdrawal via the item withdrawal zone from the pack and the dispenser and/or (b) empty pack removal via the item withdrawal zone; and wherein the empty packs reconfigure from their form when full of their items to a form more collapsed than when full, the withdrawal opening being of a perimeter profile that prevents the pack from passing through the withdrawal opening unless the pack is so reconfigured.

26. A pack for use with a dispenser as claimed in claim 26.

27. A pack for use with a dispenser system as claimed in claim 1.

28. A system as claimed in claim 1 wherein the pack has an extension that extends when in use in the dispenser, outside of the dispenser.

29. A system as claimed in claim 1 wherein the extension is part of a removable member of the pack.

30. A system as claimed in anyone of claims 1 to 23 wherein a said pack when removed from the withdrawal opening has its bottom wall pulled through first, whilst the top wall interacts with a wall of the dispenser at the dispensing opening, to thereby cause the pack to move to a more flattened condition to allow the pack to be removed from the dispenser through the dispensing opening.

31. A pack of items, the items being available, or releasable so as to be available, for progressive withdrawal from the pack itself; wherein when none of the items have been withdrawn, the pack is of a thickness greater than that which it assumes, or can be caused to assume, when the pack is depleted of said items; and wherein, when the last of the items to be withdrawn is withdrawn, a pull zone for the depleted pack is revealed.

32. A pack as claimed in claim 31 wherein the pull zone is configured to collapse the pack when pulled.

33. A pack as claimed in claim 31 or 32 wherein the pack is configured to collapse when pulled at the pull zone, and pulled in the direction through a guide opening that is smaller than the area of the pack in the direction of the pull.

34. A dispenser suitable for dispensing packs containing items each able to be dispensed from the pack when in the dispenser, the dispenser comprising a dispensing pack and a housing having a first wall opening to a containment region inside the housing via which a plurality of said dispensing packs can be loaded into the housing in a stack formation and a second wall opening of the housing allowing serial item withdrawal until a dispensing pack is empty of items, from the lowermost pack in the stack in the housing presented at the second wall opening and thereafter removal, via the second wall opening, of the empty dispensing pack and a pack of items, the items being available, or releasable so as to be available, for progressive withdrawal from the dispensing pack itself through the second wall opening; wherein when none of the items have been withdrawn, the dispensing pack is of a thickness greater than that which it assumes, or can be caused to assume, when the pack is empty of said items and is larger than the second wall opening to prevent its removal through the second wall opening; and wherein, when the last of the items to be withdrawn is withdrawn, the empty dispensing pack is able to be pulled out of the second wall opening, the pack is configured to collapse when pulled at a pull zone of the pack, and pulled in the direction through a the second wall opening that is smaller than the area of the pack in the direction of the pull.

35. A dispenser as claimed in claim 34 wherein a pull zone for the empty pack is revealed when the last item is removed from the pack.

36. A collapsible pack containing a plurality of items to be dispensed from the pack when in a dispenser having a housing with a dispensing opening via which the items in the pack can be grasped by a user for removal from the pack, the pack having at least two opposed walls and a base end at least partially enveloping and retaining a plurality of said items, the items presented at an end opposite the base end where the items can be grasped for removal, the pack being of a form that before removal of items cannot pass through the dispensing opening due to items keeping the two opposed sidewalls apart enough to prevent pack removal via the dispensing opening and that that once items are removed the pack can be grasped and pulled through the dispensing opening thereby collapsing the sidewalls permitting removal of the pack.

37. A pack as claimed in claim 36 wherein an EID tag is secured to the base.

38. A pack as claimed in claim 37 wherein at the base, the pack provides a spacer that spaces the items from the EID and creates a void between the items and the EID.

39. A pack as claimed in claim 38 wherein the spacer is of a configuration to also collapse when the pack is removed from the dispensing opening.

40. A pack as claimed in anyone of claims 37 to 39 wherein the EID is spaced at least 5 mm from the items.

41. A pack as claimed in anyone of claims 37 to 39 wherein the EID is spaced at least 10 mm from the items.

42. A pack as claimed in anyone of claims 37 to 39 wherein the EID is spaced at least 20 mm from the items.
